(19) United States
(12) Patent Application Publication
(10) Pub. No.: US 2025/0106615 A1
(43) Pub. Date: Mar. 27, 2025

(54) ESIM REPROVISIONING FOLLOWING ESIM DELETION

(71) Applicant: T-Mobile USA, Inc., Bellevue, WA (US)

(72) Inventors: Anjani Nandigam, Bothell, WA (US); Zoltan Homorodi, North Bend, WA (US); Nilesh Ranjan, Sammamish, WA (US)

(21) Appl. No.: 18/474,420

(22) Filed: Sep. 26, 2023

(51) Int. Cl. H04W 8/20

(52) U.S. Cl. CPC H04W 8/20

(57) ABSTRACT

An eSIM server, entitlement server, and user equipment (UE) of a telecommunications network are described herein. Following deletion of an eSIM from the UE, the UE may request the eSIM from the telecommunications network. Based on an active subscription associated with the UE, the entitlement server determines that the deleted eSIM should be provided to the UE and manages the eSIM server and UE to ensure this. The eSIM server stores the deleted eSIM and other eSIMs, along with their statuses. Following the deletion of the eSIM, the eSIM server maintains a quarantine status for the eSIM and, following instruction to update the eSIM status to a released status from the entitlement server, provides the eSIM to the UE.

### BACKGROUND

Embedded subscriber identity modules (eSIMs) are provisioned to user equipment (UE) when the UEs are first activated to securely store subscriber information and enable access to a telecommunications network. These UEs, such as mobile phones, watches, goggles, etc., often download updates or new applications, which may result in unintentional deletions of eSIMs. User mistake or error can also cause eSIM deletion. The result in any case is the assignment and downloading of a completely new eSIM from the telecommunications network. The process to achieve this involves burdens on network resources, such as billing server, entitlement servers, eSIM storage, etc. And because deleted eSIMs may at least be temporarily unavailable for reassignment to other UEs, assignment of new eSIMs results in greater numbers of eSIMs being needed for the telecommunications network.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is a diagram of a telecommunications network having an eSIM server to store eSIMs and their statuses, an entitlement server to manage eSIM reprovisioning, and a UE that requests and receives its previously provisioned eSIM following the unintentional deletion of that eSIM.

FIG. 2 is a flow diagram of an illustrative process at an entitlement server that instructs an eSIM server to provide an eSIM to a UE that was deleted by the UE.

FIG. 3 is a flow diagram of an illustrative process at an eSIM server for maintaining a status of an eSIM deleted from its UE as a quarantine status as long as the subscription for the UE is active and for providing the eSIM deleted from its UE back to the UE following instruction from an entitlement server.

FIG. 4 is a flow diagram of an illustrative process at a UE that provides a user of the UE with an option to retrieve an eSIM following its deletion.

FIG. 5 is a schematic diagram of a computing device capable of implementing functionality of at least one of the entitlement server, the eSIM server, or the UE.

### DETAILED DESCRIPTION

This disclosure is directed in part to an eSIM server, entitlement server, and user equipment (UE) of a telecommunications network. Following deletion of an eSIM from the UE, the UE may request that deleted eSIM from the telecommunications network. The deletion may have been unintentional (e.g., a user mistake, a program error, etc.) and there may be no changes to the user's subscription. The request for the deleted eSIM may be sent to the entitlement server and, based on the user of the UE having an active subscription, the entitlement server may determine that the deleted eSIM should be provided to the UE and manages the eSIM server and UE to ensure this. In some implementations, even if the request from the UE is not specifically for the deleted eSIM, the entitlement server may determine that the deleted eSIM should be provided to the UE.

The eSIM server stores the deleted eSIM and other eSIMs, along with their statuses. Following the deletion of the eSIM from the UE, the eSIM server maintains a quarantine status for the deleted eSIM and, following instruction from the entitlement server to update the eSIM status to a released status, provides the deleted eSIM to the UE. The eSIM server may do so automatically, through push distribution, or may await a request from the UE for the deleted eSIM.

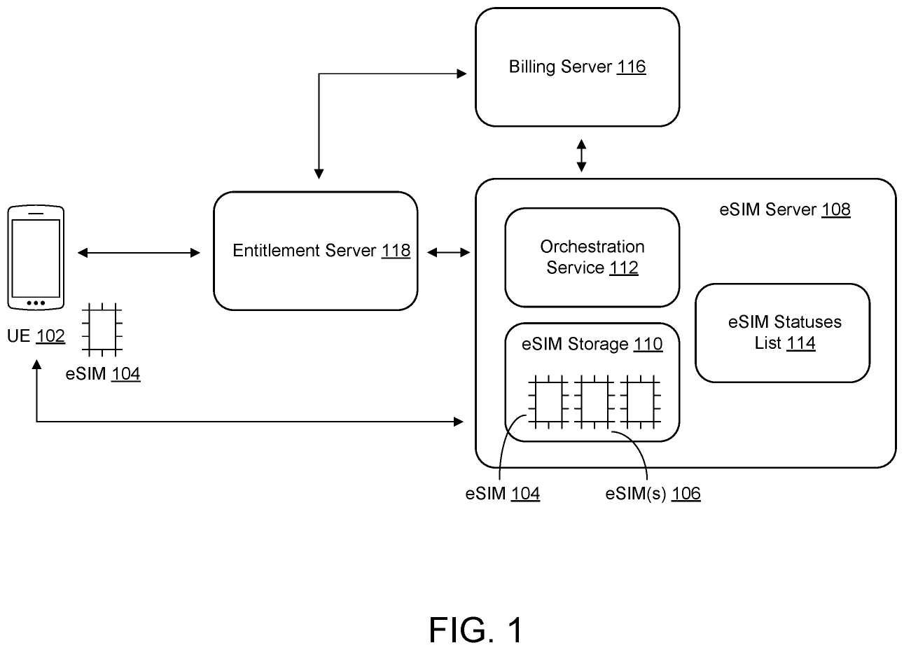

FIG. 1 is a diagram of a telecommunications network having an eSIM server to store eSIMs and their statuses, an entitlement server to manage eSIM reprovisioning, and a UE that requests and receives its previously provisioned eSIM following the unintentional deletion of that eSIM. As illustrated, a UE 102 may delete from itself an eSIM 104 that, along with other eSIM(s) 106 may be stored by an eSIM server 108. The eSIM server 108 may include an eSIM storage 110 (storing, e.g., eSIM 104 and eSIM(s) 106), an orchestration service 112, and a list 114 of eSIM statuses. The eSIM server 108 may interact with a billing server 116 to determine whether the user of the UE 102 is an active subscriber and with an entitlement server 118 that may instruct the eSIM server 108 to release/provide an eSIM 104/eSIM 106.

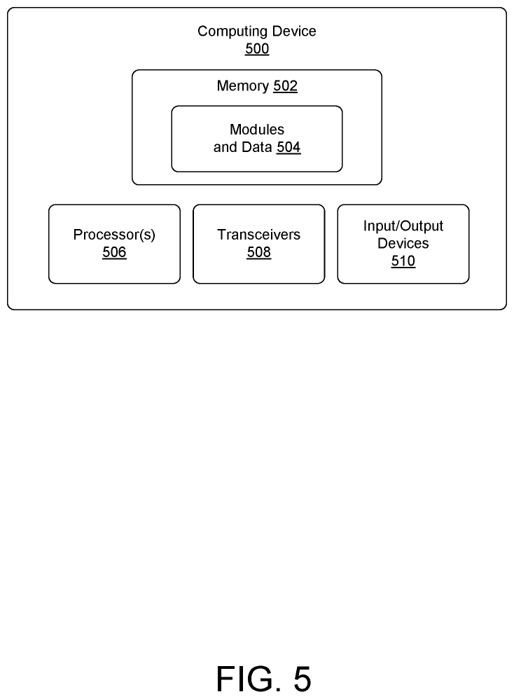

The UE 102 may be any sort of UE, such as a cellular phone, a mobile device, a watch, goggles, an Internet-of-Things device (e.g., a wearable device, etc.), a tablet computer, a personal computer (PC), or any sort of device capable of wireless connectivity to one or more access points and of being moved from location to location. An example UE 102 is illustrated in FIG. 5 and described further herein with reference to that figure.

In some implementations, the UE 102 may have an eSIM 104 allocated to it that holds subscriber profiles with information such as a mobile station international subscriber directory number (MSISDN), an international mobile subscriber identity (IMSI), etc. The information may be provided by the UE 102 to telecommunications network from the eSIM 104 in order to authenticate with the network and obtain authorization for communications using it. The eSIM 104 may also be deleted. Deletion may be intentional, such as when a user of the UE 102 cancels a subscription with the telecommunications network, or unintentional. Unintentional deletions may be caused by accident or mistake (e.g., user hits the wrong key) or by program error (e.g., an update deletes the eSIM 104).

Responsive to the deletion, the UE 102 sends a notification to the eSIM server 108 that the eSIM 104 has been deleted. The eSIM server 108 may be any one or more computing devices of the telecommunications network and may itself include an eSIM storage 110, orchestration service 112, and list 114 of eSIM statuses. The eSIM storage 110 may be any sort of storage capable of storing the eSIM 104 and one or more other eSIM(s) 106. The orchestration service 112 may handle interactions with other nodes/devices for the eSIM server 108, including eSIM provisioning and eSIM status updates, among other functions. The list 114 may store an identifier for each eSIM 104/106, a status for that eSIM 104/106 (e.g., quarantine, released, etc.), and, if a subscriber is associated with the eSIM 104/106, a subscriber identifier (in other implementations, a different identifier, such as an identifier for the UE 102, may be used). An example of such computing device(s) constituting the eSIM server 108 is illustrated in FIG. 5 and described further with reference to that figure.

In various implementations, the eSIM server 108 sets the status for eSIM 104 to a quarantine status upon receiving the deletion notification from the UE 102. The eSIM server 108 then maintains the status as a quarantine status as long as the subscription associated with it by the list 114 is an active subscription or until instruction is received (e.g., from the entitlement server 118) to set the status of the eSIM 104 to a release status.

In some implementations, the eSIM server 108 is configured to check periodically with a billing server 116 whether there is an active subscription associated with the subscriber having UE 102. If the status of the subscription changes to inactive or cancelled, the eSIM server 108 may update the list 114 to remove the association between the eSIM 104 and the subscriber associated with UE 102. The eSIM server 108 may also update the status of the eSIM in the list 114 or set a timer after which the status is automatically updated. Following an update of status from quarantine and following the removal of the association with a subscriber, an eSIM 104/106 may be assigned and provided to another UE as a new eSIM.

In various implementations, a process to reprovision the UE 102 with the deleted eSIM 104 may be initiated by the UE 102. The process may be triggered by the deletion of the eSIM 104, by an attempt to connect to the telecommunications network, by an attempt to use a feature of the UE 102 that requires a connection with the telecommunications network, or by some other mechanism. The process may be surfaced to the user of the UE 102 or conducted without user interaction. When surfacing to the user, the UE 102 may provide a prompt or UE 102 asking the user to confirm that the deletion of the eSIM 104 was unintentional, accidental, a mistake, etc. The UE 102 may also ask the user whether the user would like the same eSIM 104. Alternatively, the user may not be given an option and the same eSIM 104 may be sought so long as the user maintains an active subscription.

Once the reprovisioning process is initiated, the UE 102 may send a request to the telecommunications network for reprovisioning of the deleted eSIM 104. Before the eSIM 104 is provided to the UE 102, the entitlement server 118 ensures that the request is associated with an eSIM 104 having a quarantine status and a subscription that is active. The entitlement server 118 may be any sort of computing device or devices and may be part of the telecommunications network. An example entitlement server 118 is shown in FIG. 5 and described below in detail with reference to that figure.

The request from the UE 102 is thus received by the entitlement server 118, which queries the billing server 116 for a subscription status associated with the UE 102 and queries the eSIM server 108 for an indication that the UE 102 (or its subscriber) is associated with an eSIM 104 having a quarantine status. In some implementations, the entitlement server 118 performs these queries responsive to the request from the UE 102 indicating that the request is for reprovisioning of a deleted eSIM. In other implementations, the entitlement server 118 performs the queries anytime there is a request for an eSIM from a UE. In such other implementations, the UE 102 need not specifically request the deleted eSIM 104 but, by virtue of the configuration of the entitlement server 118, will receive the deleted eSIM 104 regardless.

Upon determining that there is a deleted eSIM 104 to reprovision for an active account, the entitlement server 118 instructs the eSIM server 108 to updated the status of the eSIM 104 from the quarantine status to a release status to enable it to be provided to the UE 102. In some implementations, the eSIM server 108 may then simply do a push distribution of the deleted eSIM 104 to the UE 102. In other implementations, the entitlement server both instructs the eSIM 104 to update eSIM status and the UE 102 to request the eSIM 104 from the eSIM server 108. In such implementations, the UE 102, upon receiving the instruction from the entitlement server 118, requests the eSIM 104 from the eSIM server 108. The eSIM server 108, with the status of the eSIM 104 updated to a release status, responds to the UE 102 request by providing the eSIM 104 to the UE 102.

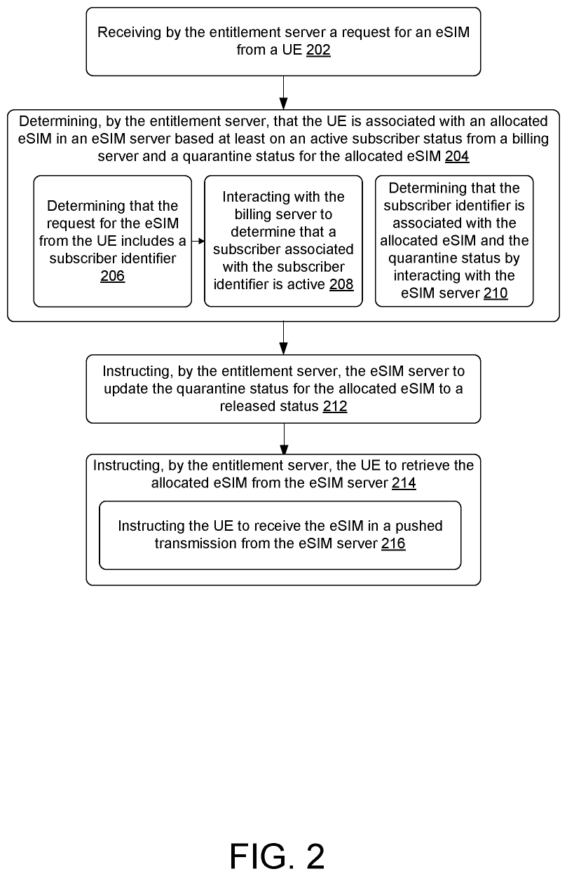

FIGS. 2-4 illustrate example processes. These processes are illustrated as logical flow graphs, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be omitted or combined in any order and/or in parallel to implement the processes.

FIG. 2 is a flow diagram of an illustrative process at an entitlement server that instructs an eSIM server to provide an eSIM to a UE that was deleted by the UE. As illustrated at 202, an entitlement server receives a request for an eSIM from a user equipment (UE). In some examples, the request for the eSIM from the UE may indicate that the UE previously retrieved and deleted the allocated eSIM. Also, the request for the eSIM from the UE may be a request to retrieve the allocated eSIM.

At 204, the entitlement server determines that the UE is associated with an allocated eSIM in an eSIM server based at least on an active subscriber status from a billing server and a quarantine status for the allocated eSIM. That determining may include, at 206, determining that the request for the eSIM from the UE includes a subscriber identifier and, at 208, interacting with the billing server to determine that a subscriber associated with the subscriber identifier is active. In some implementations, the determining may also or instead include, at 210, determining that the subscriber identifier is associated with the allocated eSIM and the quarantine status by interacting with the eSIM server.

At 212, the entitlement server instructs the eSIM server to update the quarantine status for the allocated eSIM to a released status.

At 214, the entitlement server instructs the UE to retrieve the allocated eSIM from the eSIM server. At 216, instructing the UE to retrieve the allocated eSIM from the eSIM server may comprise instructing the UE to receive the eSIM in a pushed transmission from the eSIM server.

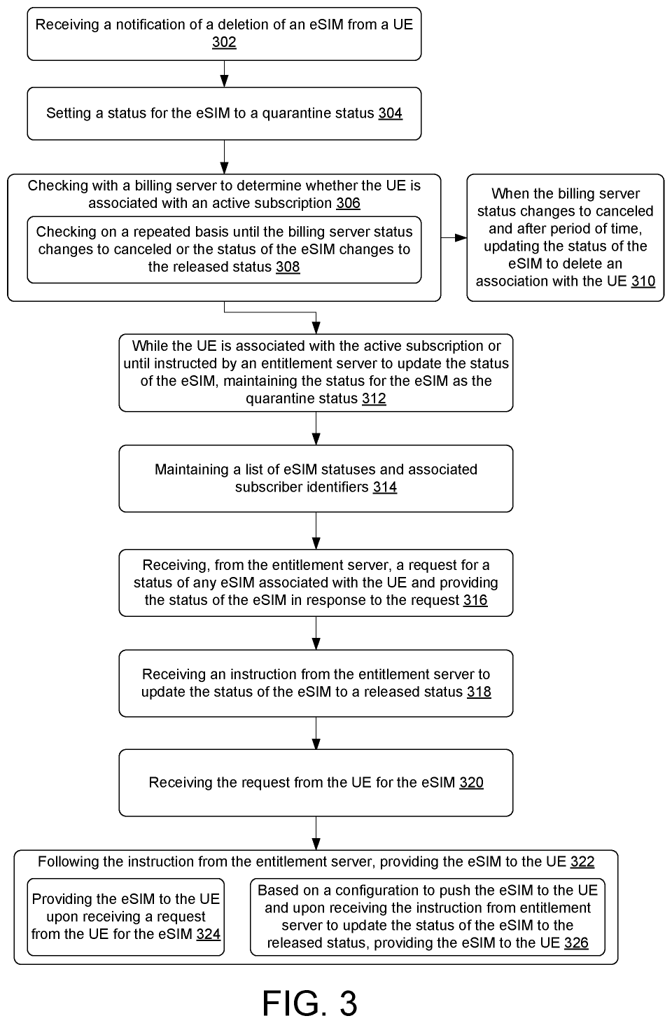

FIG. 3 is a flow diagram of an illustrative process at an eSIM server for maintaining a status of an eSIM deleted from its UE as a quarantine status as long as the subscription for the UE is active and for providing the eSIM deleted from its UE back to the UE following instruction from an entitlement server. In some implementations, the eSIM server includes an orchestration service and an eSIM storage. As illustrated at 302, an eSIM server receives a notification of a deletion of an eSIM from a user equipment (UE).

At 304, the eSIM server sets a status for the eSIM to a quarantine status.

At 306, the eSIM server checks with a billing server to determine whether the UE is associated with an active subscription. At 308, the checking may comprise checking on a repeated basis until the billing server status changes to canceled or the status of the eSIM changes to the released status.

At 310, if the billing server status changes to canceled and, after period of time, the eSIM server may update the status of the eSIM to delete an association with the UE.

At 312, while the UE is associated with the active subscription or until instructed by an entitlement server to update the status of the eSIM, the eSIM server maintains the status for the eSIM as the quarantine status.

In some implementations, at 314, the eSIM server maintains a list of eSIM statuses and associated subscriber identifiers. The maintaining at 314 may occur before, during, and/or after any of operations 302-312 and 316-326.

In further implementations, at 316, the eSIM server receives, from the entitlement server, a request for a status of any eSIM associated with the UE and provides the status of the eSIM in response to the request.

At 318, the eSIM server receives an instruction from the entitlement server to update the status of the eSIM to a released status.

At 320, the eSIM server may receive the request from the UE for the eSIM.

At 322, following the instruction from the entitlement server, the eSIM server provides the eSIM to the UE. In some implementations, the providing includes, at 324, providing the eSIM to the UE upon receiving a request from the UE for the eSIM. Alternatively, at 326, the providing may include, based on a configuration to push the eSIM to the UE and upon receiving the instruction from entitlement server to update the status of the eSIM to the released status, providing the eSIM to the UE.

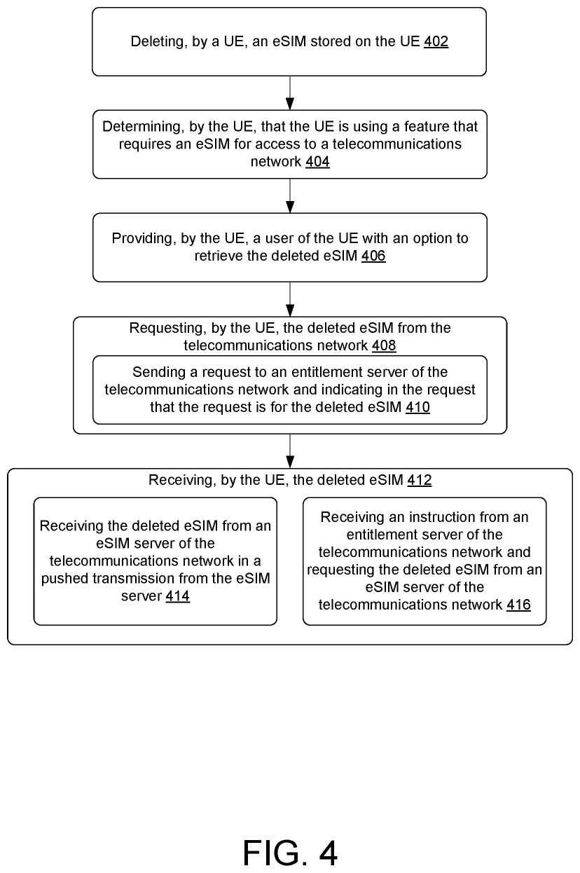

FIG. 4 is a flow diagram of an illustrative process at a UE that provides a user of the UE with an option to retrieve an eSIM following its deletion. As illustrated at 402, the UE deletes an eSIM stored on the UE. The deleting of the deleted eSIM may be accidental, unintentional, or a program error. Also, in some implementations, the UE may be a watch, a mobile device, goggles, a wearable device, or an IoT device.

At 404, the UE determines that the UE is using a feature that requires an eSIM for access to a telecommunications network.

At 406, the UE provides a user of the UE with an option to retrieve the deleted eSIM.

At 408, the UE requests the deleted eSIM from the telecommunications network. At 410, the requesting may comprise sending a request to an entitlement server of the telecommunications network and indicating in the request that the request is for the deleted eSIM.

At 412, the UE receives the deleted eSIM. At 414, the receiving may comprise receiving the deleted eSIM from an eSIM server of the telecommunications network in a pushed transmission from the eSIM server. Alternatively, at 416, the receiving may comprise receiving an instruction from an entitlement server of the telecommunications network and requesting the deleted eSIM from an eSIM server of the telecommunications network.

FIG. 5 is a schematic diagram of a computing device capable of implementing functionality of at least one of the entitlement server, the eSIM server, or the UE. As shown, the computing device 500 includes a memory 502 storing modules and data 504, processor(s) 506, transceivers 508, and input/output devices 510.

In various examples, the memory 502 can include system memory, which may be volatile (such as RAM), non-volatile (such as ROM, flash memory, etc.) or some combination of the two. The memory 802 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store the desired information.

The memory 502 can include one or more software or firmware elements, such as computer-readable instructions that are executable by the one or more processors 506. For example, the memory 502 can store computer-executable instructions associated with modules and data 504. The modules and data 504 can include a platform, operating system, and applications, and data utilized by the platform, operating system, and applications. Further, the modules and data 504 can implement any of the functionality for the UE 102, entitlement server 118, billing server 116, eSIM server 108, orchestration service 112, eSIM storage 110, or any other node/device described and illustrated herein. Further, when the computing device 500 is the UE 102, eSIM server 108, or eSIM storage 110, the modules and data 504 may include eSIM 104 and/or eSIM(s) 106. Additionally, when the computing device 500 is the eSIM server 108, the modules and data 504 may include the list 114 of eSIM statuses.

In various examples, the processor(s) 506 can be a central processing unit (CPU), a graphics processing unit (GPU), or both CPU and GPU, or any other type of processing unit. Each of the one or more processor(s) 506 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 506 may also be responsible for executing all computer applications stored in the memory 502, which can be associated with types of volatile (RAM) and/or nonvolatile (ROM) memory.

The transceivers 508 can include modems, interfaces, antennas, Ethernet ports, cable interface components, and/or other components that perform or assist in exchanging wireless communications, wired communications, or both.

While the computing device need not include input/output devices 510, in some implementations it may include one, some, or all of these. For example, the input/output devices 510 can include a display, such as a liquid crystal display or any other type of display. For example, the display may be a touch-sensitive display screen and can thus also act as an input device or keypad, such as for providing a soft-key keyboard, navigation buttons, or any other type of input. The input/output devices 510 can include any sort of output devices known in the art, such as a display, speakers, a vibrating mechanism, and/or a tactile feedback mechanism. Output devices can also include ports for one or more peripheral devices, such as headphones, peripheral speakers, and/or a peripheral display. The input/output devices 510 can include any sort of input devices known in the art. For example, input devices can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

Although features and/or methodological acts are described above, it is to be understood that the appended claims are not necessarily limited to those features or acts. Rather, the features and acts described above are disclosed as example forms of implementing the claims.

What is claimed is:

1. A method comprising:
receiving, by an entitlement server, a request for an eSIM from a user equipment (UE);
determining, by the entitlement server, that the UE is associated with an allocated eSIM in an eSIM server based at least on an active subscriber status from a billing server and a quarantine status for the allocated eSIM;
instructing, by the entitlement server, the eSIM server to update the quarantine status for the allocated eSIM to a released status; and
instructing, by the entitlement server, the UE to retrieve the allocated eSIM from the eSIM server.

2. The method of claim 1, wherein the request for the eSIM from the UE indicates that the UE previously retrieved and deleted the allocated eSIM.

3. The method of claim 1, wherein the request for the eSIM from the UE is a request to retrieve the allocated eSIM.

4. The method of claim 1, wherein the determining comprises:
determining that the request for the eSIM from the UE includes a subscriber identifier; and
interacting with the billing server to determine that a subscriber associated with the subscriber identifier is active.

5. The method of claim 4, wherein the determining comprises determining that the subscriber identifier is associated with the allocated eSIM and the quarantine status by interacting with the eSIM server.

6. The method of claim 1, wherein the instructing the UE to retrieve the allocated eSIM from the eSIM server comprises instructing the UE to receive the eSIM in a pushed transmission from the eSIM server.

7. An eSIM server comprising:
one or more processors; and
a plurality of programming instructions that, when executed by the one or more processors, cause the one or more processors to perform operations including:
receiving a notification of a deletion of an eSIM from a user equipment (UE);
setting a status for the eSIM to a quarantine status;
checking with a billing server to determine whether the UE is associated with an active subscription;
while the UE is associated with the active subscription or until instructed by an entitlement server to update the status of the eSIM, maintaining the status for the eSIM as the quarantine status;
receiving an instruction from the entitlement server to update the status of the eSIM to a released status; and
following the instruction from the entitlement server, providing the eSIM to the UE.

8. The eSIM server of claim 7, wherein the checking comprises checking on a repeated basis until a billing server status changes to canceled or the status of the eSIM changes to the released status.

9. The eSIM server of claim 8, wherein the operations further comprise, when the billing server status changes to canceled and after period of time, updating the status of the eSIM to delete an association with the UE.

10. The eSIM server of claim 7, wherein the operations further comprise receiving, from the entitlement server, a request for a status of any eSIM associated with the UE and providing the status of the eSIM in response to the request.

11. The eSIM server of claim 7, wherein the providing the eSIM to the UE comprises:
providing the eSIM to the UE upon receiving a request from the UE for the eSIM; or
based on a configuration to push the eSIM to the UE and upon receiving the instruction from entitlement server to update the status of the eSIM to the released status, providing the eSIM to the UE.

12. The eSIM server of claim 11, wherein the operations further comprise receiving the request from the UE for the eSIM.

13. The eSIM server of claim 7, wherein the eSIM server includes an orchestration service and an eSIM storage.

14. The eSIM server of claim 7, wherein the operations further comprise maintaining a list of eSIM statuses and associated subscriber identifiers.

15. A method comprising:
deleting, by a user equipment (UE), an eSIM stored on the UE;
determining, by the UE, that the UE is using a feature that requires an eSIM for access to a telecommunications network;
providing, by the UE, a user of the UE with an option to retrieve the deleted eSIM;
requesting, by the UE, the deleted eSIM from the telecommunications network; and
receiving, by the UE, the deleted eSIM.

16. The method of claim 15, wherein the UE is a watch, a mobile device, goggles, a wearable device, or an Internet-of-Things (IoT) device.

17. The method of claim 15, wherein the requesting comprises sending a request to an entitlement server of the telecommunications network and indicating in the request that the request is for the deleted eSIM.

18. The method of claim 15, wherein the receiving comprises receiving the deleted eSIM from an eSIM server of the telecommunications network in a pushed transmission from the eSIM server.

19. The method of claim 15, wherein the receiving comprises receiving an instruction from an entitlement server of the telecommunications network and requesting the deleted eSIM from an eSIM server of the telecommunications network.

20. The method of claim 15, wherein the deleting of the deleted eSIM was accidental, unintentional, or a program error.
